(19) United States
(12) Patent Application Publication
(10) Pub. No.: US 2019/0128099 A1
(43) Pub. Date: May 2, 2019

(54) MULTIPLE EVENT TRIGGER AND ACTUATION SYSTEM

(71) Applicant: Roy Woudwijk, Spring, TX (US)

(72) Inventor: Roy Woudwijk, Spring, TX (US)

(73) Assignee: Baker Hughes, a GE company, LLC, Houston, TX (US)

(21) Appl. No.: 15/795,938

(22) Filed: Oct. 27, 2017

(51) Int. Cl. E21B 34/10; F16K 17/40; E21B 34/06

(52) U.S. Cl. CPC E21B 34/10; F15B 15/1423; E21B 34/063; F16K 17/403

(57) ABSTRACT

A multiple event trigger and actuation system including an actuator having an actuation component, a frangible dome and a pressure shiftable sleeve, a trigger having an incrementally movable stem, a holding configuration operably connected to the stem and configured to allow an incremental movement at a time based upon a pressure cycle and then hold the stem in such incremented position, and a rupture disk, the disk being positioned between a port to a pressure source and a trigger chamber, and a trigger transfer sleeve operatively connected to the shiftable sleeve to cause movement of the shiftable sleeve upon movement of the trigger transfer sleeve.

### BACKGROUND

In resource recovery industries, actuations of tools remotely are often desired. Many times an increased pressure event may be employed to cause response in a trigger that then will cause a cascade reaction of planned movements resulting in motion that causes the ultimate actuation of the tool. Commonly, the Triggers are responsive to a particular pressure threshold and when that is reached the trigger will activate. In some cases though other operations could potentially cause pressure events that might prematurely activate the trigger. In other situations, it might be helpful to have a number of triggers that respond to the same stimulus but do so at different prescribed times. The art therefore would well receive configurations that provide such control.

### SUMMARY

A multiple event trigger and actuation system including an actuator having an actuation component, a frangible dome and a pressure shiftable sleeve, a trigger having an incrementally movable stem, a holding configuration operably connected to the stem and configured to allow an incremental movement at a time based upon a pressure cycle and then hold the stem in such incremented position, and a rupture disk, the disk being positioned between a port to a pressure source and a trigger chamber, and a trigger transfer sleeve operatively connected to the shiftable sleeve to cause movement of the shiftable sleeve upon movement of the trigger transfer sleeve.

A method for activating a multiple event trigger and actuation system including exposing the system as in any previous embodiment, to more than one pressure event before activation of the system, incrementing the trigger, porting pressure to the trigger chamber, moving the trigger transfer sleeve with the ported pressure, moving the shiftable sleeve with the trigger transfer sleeve, and actuating the actuator.

### BRIEF DESCRIPTION OF THE DRAWINGS

The following descriptions should not be considered limiting in any way. With reference to the accompanying drawings, like elements are numbered alike:

FIG. 1 illustrates an actuation system having an actuator and a trigger for the actuator in an untriggered and unactuated condition;

FIG. 2 is an enlarged view of the circumscribed 2-2 area of FIGS. 1; and

FIG. 3 illustrates the actuation system having an actuator and a trigger for the actuator in a triggered and actuated condition;

FIG. 4 is an enlarged view of the circumscribed 2-2 area of FIG. 1 illustrating the triggered position; and

FIG. 5 is a schematic representation of a borehole system configured with the trigger and actuator disclosed herein.

### DETAILED DESCRIPTION

A detailed description of one or more embodiments of the disclosed apparatus and method are presented herein by way of exemplification and not limitation with reference to the Figures.

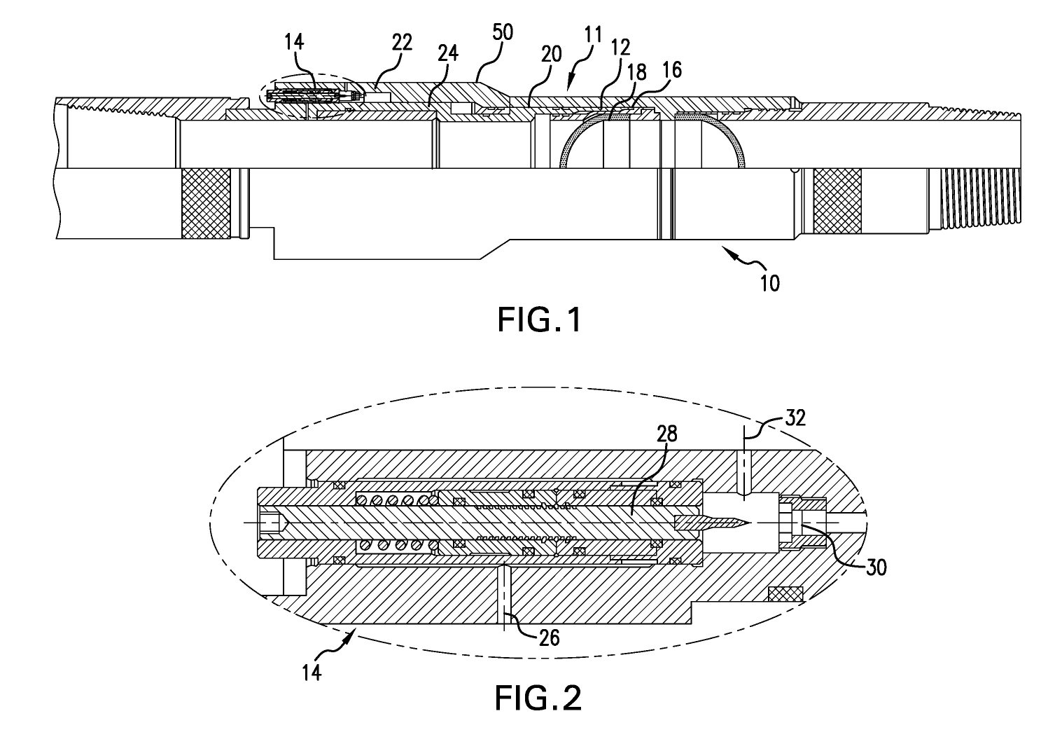

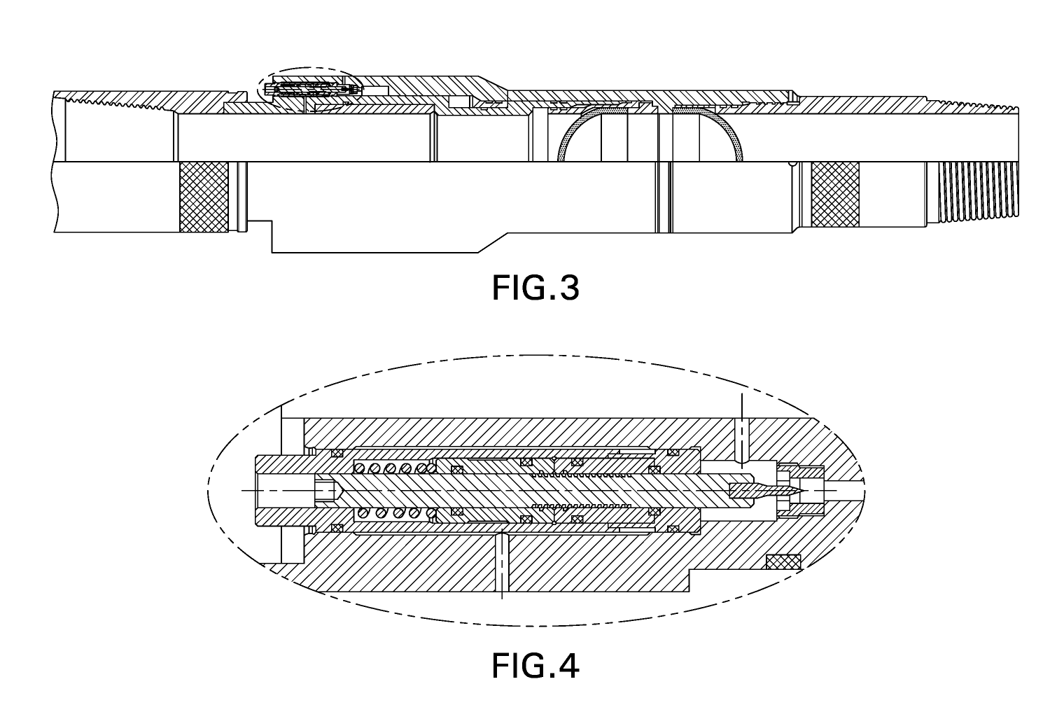

Referring to FIG. 1, a multiple event trigger and actuation system 10 is illustrated having an actuator 12 and a trigger 14. The actuator 12 includes sections similar to a commercially available product from Magnum Oil known commercially Magnum Disk and US patent publication number 2017/0022783, which is incorporated herein by reference in its entirety. These sections are the actuation component 16, a frangible dome 18 and a pressure shiftable sleeve 20. The balance of the actuator 12 is modified in order to allow the actuator 12 to be responsive to the trigger 14, which trigger is commercially known as Caledyne CBV barrier valve actuator U.S. Pat. No. 8,602,105, which is incorporated herein by reference in its entirety.

The system 10 includes a housing 11 that houses the trigger 14 and the actuator 12 in operative communication with one another. The trigger 14 allows a selected number of tubing pressure up events before allowing annulus pressure to access a trigger chamber 22. Chamber 22 is fluidically connected to trigger transfer sleeve 24, which is in operable communication with shiftable sleeve 20. In FIG. 1, it can be seen that the trigger transfer sleeve 24 is directly abutting the shiftable sleeve 20 though other configurations are also contemplated.

The trigger 14, referring to FIG. 2, includes an access port 26 to tubing pressure which allows for tubing pressure up events to cause cycling of the trigger 14. The trigger 14 may be set to cycle a number of times before activation. The trigger 14 includes an incrementally movable stem 28 configured to be retained in a new incremented position subsequent to each pressure cycle. The configuration may employ a holding configuration such as a ratcheting pawl 29 or may employ a sliding jamb member (not shown) but is commercially available as part of the Caledyne CBV barrier valve actuator. During each cycle, a stem 28 will move incrementally closer to a rupture disk 30. When enough cycles, i.e. the selected number of cycles for which the trigger 14 was set, occur the stem 28 will have come into contact with and pierced the rupture disk 30. It can be seen that there is a port 32 from the trigger 14 that accesses annulus pressure such that after rupture of the disk 30, annulus pressure is ported to the chamber 22 and the end of trigger transfer sleeve 24. Upon the sleeve 24 being exposed to annulus pressure, it will begin moving in the direction of the actuation component 16. The shiftable sleeve 20 will be shifted due to the movement of the trigger transfer sleeve 24 and will cause the actuation component 16 to put a stress on the dome 18. From this point, the function of the actuator 12 is the same as the commercially available Magnum product mentioned above. Specifically, the actuation component is urged against the dome 18 to create a significant stress increase therein resulting in the shattering of the dome 18 thereby.

In order to configure the Magnum actuator to function with the Caledyne trigger, the magnum actuator is constructed with a housing extension 50 that has dimensions and position to support the trigger 14 axially relative to housing 11. This is advantageous due to a length of the trigger 14. Housing extension 50 is configured to have fluidic access to the inside diameter of the tool to access tubing pressure for the incremental operation of the trigger 14 and is configured to port annulus fluid to the chamber 22 for activation of the system 10 subject to the stem 28 puncturing the disk 30.

As configured herein, the actuator 12 is triggerable only after a preselected number of pressure events each one of which is sufficient to cause an increment of movement of the stem 28 of the trigger. Upon reaching the preselected number of pressure events the actuator is triggered. This allows for reduced cost in number of tools employed, and reduced rig time. Rig time is reduced since multiple operations can be performed in a single run without the requirement of individual pressure event configurations being employed with different pressure thresholds but rather pressure events can be stacked and then the actuator triggered only after the selected number of pressure events has occurred.

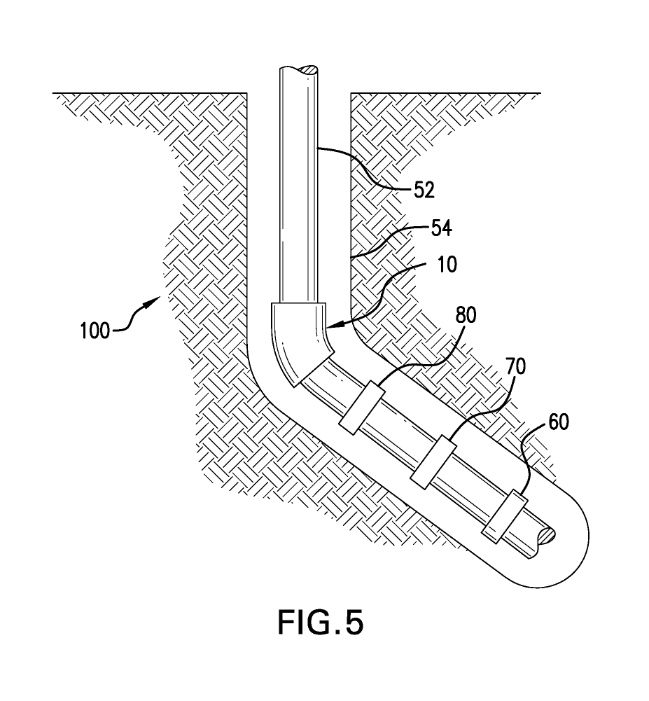

Referring to FIG. 5, a schematic view of a borehole system 100 illustrates a tubing string 52 disposed in a borehole 54, the string 52 having a number of pressure responsive tools 60, 70, and 80 therein and also a multiple event trigger and actuation system 10. Pressure events may be used to cause each of the tools 60, 70, 80 to respond individually prior to the system 10 activating to trigger the actuator 12. The overall borehole system then is significantly more efficient than prior art systems in that the multiple pressure event capability will reduce rig time and streamline installations.

Set forth below are some embodiments of the foregoing disclosure:

### Embodiment 1

A multiple event trigger and actuation system including an actuator having an actuation component, a frangible dome and a pressure shiftable sleeve, a trigger having an incrementally movable stem, a holding configuration operably connected to the stem and configured to allow an incremental movement at a time based upon a pressure cycle and then hold the stem in such incremented position, and a rupture disk, the disk being positioned between a port to a pressure source and a trigger chamber, and a trigger transfer sleeve operatively connected to the shiftable sleeve to cause movement of the shiftable sleeve upon movement of the trigger transfer sleeve.

### Embodiment 2

The system as in any previous embodiment, wherein the holding configuration includes a ratcheting pawl.

### Embodiment 3

The system in any previous embodiment, wherein the trigger transfer sleeve is directly in contact with the shiftable sleeve.

### Embodiment 4

The system in any previous embodiment, wherein the pressure source is annulus pressure.

### Embodiment 5

A method for activating a multiple event trigger and actuation system including exposing the system as in any previous embodiment, to more than one pressure event before activation of the system, incrementing the trigger, porting pressure to the trigger chamber, moving the trigger transfer sleeve with the ported pressure, moving the shiftable sleeve with the trigger transfer sleeve, and actuating the actuator.

### Embodiment 6

The method as in any previous embodiment, wherein the incrementing occurs as one increment per pressure event.

### Embodiment 7

The method as in any previous embodiment, wherein the porting of pressure is porting annulus pressure.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A multiple event trigger and actuation system comprising:
an actuator having an actuation component, a frangible dome and a pressure shiftable sleeve;
a trigger having an incrementally movable stem, a holding configuration operably connected to the stem and configured to allow an incremental movement at a time based upon a pressure cycle and then hold the stem in such incremented position, and a rupture disk, the disk being positioned between a port to a pressure source and a trigger chamber; and
a trigger transfer sleeve operatively connected to the shiftable sleeve to cause movement of the shiftable sleeve upon movement of the trigger transfer sleeve.

2. The system as claimed in claim 1 wherein the holding configuration includes a ratcheting pawl.

3. The system as claimed in claim 1 wherein the trigger transfer sleeve is directly in contact with the shiftable sleeve.

4. The system as claimed in claim 1 wherein the pressure source is annulus pressure.

5. A method for activating a multiple event trigger and actuation system comprising:
exposing the system as claimed in claim 1 to more than one pressure event before activation of the system;
incrementing the trigger;
porting pressure to the trigger chamber;
moving the trigger transfer sleeve with the ported pressure;
moving the shiftable sleeve with the trigger transfer sleeve; and
actuating the actuator.

6. The method as claimed in claim 5 wherein the incrementing occurs as one increment per pressure event.

7. The method as claimed in claim 5 wherein the porting of pressure is porting annulus pressure.
